(19) United States
(12) Patent Application Publication
(10) Pub. No.: US 2018/0298641 A1
(43) Pub. Date: Oct. 18, 2018

(54) A LOCK DEVICE

(71) Applicant: Bekey A/S, Høje Taastrup (DK)

(72) Inventor: Sigurd Rasmussen, Rødvig Stevns (DK)

(21) Appl. No.: 15/568,688

(22) PCT Filed: Apr. 21, 2016
(86) PCT No.: PCT/EP2016/058851

§ 371 Date: Oct. 23, 2017

(30) Foreign Application Priority Data
Apr. 24, 2015 (DK) PA201570240

(51) Int. Cl. E05B 47/00; E05B 63/00; E05B 15/02

(52) U.S. Cl. CPC E05B 47/0012; E05B 63/0056; E05B 2047/002; E05B 2047/0091; E05B 15/02

(57) ABSTRACT

A lock device configured for activating the lock catch 7 of a lock by rotating a lock axle between a locked and an unlocked position, the lock device comprising a lock activator with a housing 1 comprising a base plate 3, at least one electrical motor, a control system configured for activation of the electrical motor, and a rotatable activator axle 2 connected to the electrical motor via a transmission and extending out of the housing 1 through the base plate 3, and wherein the lock device further comprises an adaptor plate 9 comprising a front surface configured for releasable attachment of the base plate 3 of the housing, and a through hole arranged so that the rotatable activator axle 2 extends through the through hole and out from a rear surface opposite to the front surface on the adaptor plate 9, and where a set of transmission elements are arranged on the rear surface of the base plate, the transmission element comprising at least a first transmission element 10 connected to the activator axle 2, and a second transmission element 11 configured for being connected to the lock axle, and where the transmission 10, 11 elements are configured for urging the second transmission element 11, and thereby the lock axle, to rotate, when the rotatable activator axle 2 is rotated.

### THE PRIOR ART

The present invention relates to a lock device or more specifically a lock activation device configured for activating the lock catch of a lock by rotating a lock axle between a locked and an unlocked position, the lock device comprising a lock activator with a housing comprising a base plate, at least an electrical motor, a control system configured for activation of the electrical motor, and a rotatable activator axle connected to the electrical motor via a transmission and extending out of the housing through the base plate.

Lock devices of the above mentioned kind are well known in many different embodiments, e.g. from WO 2006098690 where the lock device is configured for being mounted on e.g. a door leaf or another lockable wing construction having a lock arranged in a cavity in the door leaf and where the lock is constructed so that the lock catch may be activated via a lock axle extending through a hole arranged in one side face (e.g. the side face of the door facing inwardly to a space in a building) and leading to the lock in the cavity.

### THE OBJECT OF THE INVENTION

On this background it is the purpose of the present invention to provide a lock device providing e.g. the option of adapting the lock device to be used with more different door locks.

According to the present invention this is achieved when the lock device further comprises an adaptor plate with a front surface configured for releasable attachment of the base plate of the housing, and a through hole arranged so that the rotatable activator axle ex-tends through the through hole and out from a rear surface opposite to the front surface on the base plate, and where a set of transmission elements are arranged on the rear surface of the base plate, the transmission element comprising at least a first transmission element connected to the activator axle, and a second transmission element configured for being connected to the lock axle, and where the transmission elements are configured for urging the second transmission element, and thereby the lock axle, to rotate, when the rotatable activator axle is rotated.

In a preferred embodiment the first and the second transmission element are cog wheels, being directly interconnected or indirectly via a one or more further cog wheels, tooth racks or other toothed elements, and where each of the first and the second cog wheels have a central through hole configured for mounting the first and the second cog wheel on the activator axle and lock axle respectively, so that the first and the second cog wheels rotate with the axles.

In this relation the lock device preferably comprises an odd number of further cog wheels.

In an alternative embodiment the first and the second transmission element are sprocket wheels, being interconnected via a toothed belt or a chain.

Preferably the adaptor plate comprises a cover plate connected to the base plate, and covering the set of transmission elements so that they are enclosed between the base plate and the cover plate.

This cover plate may advantageously comprise a metal plate and the base plate is made from plastic and preferably from a thermosetting plastic material.

In a further preferred embodiment the cover plate has a through hole allowing a lock axle to extend through the cover plate, and to be connected with the second transmission element, and where the base plate extends over the through hole in the cover plate.

Furthermore the cover plate or the base plate may advantageously comprise projections or indentations arranged on the side facing the base plate or the cover plate respectively, and where the projections or indentations are configured for positioning the transmission elements.

An especially easy mounting of the lock device is achieved when the complete outer periphery of the base plate extends along the complete outer periphery of the cover plate.

In a preferred embodiment the through holes in the first and the second cog wheel are identical.

### THE DRAWING

In the following one or more embodiments of the invention will be described in more detail and with reference to the drawing, where:

FIG. 1: Is a perspective drawing, shown a lock activation device according to prior art.

FIG. 2: Is a side view of the activation device shown in FIG. 1.

FIG. 3: Is a principle sketch showing a section of a door wing provided with the prior art lock activation device lock shown in FIGS. 1 and 2 and alternatively a lock activation device with an adapter according to the invention.

FIG. 4: Is an exploded view of the adapter shown in FIG. 3.

FIG. 5: Is an exploded view of an alternative embodiment of an adapter according to the invention.

### DESCRIPTION OF EXEMPLARY EMBODIMENTS

FIGS. 1 and 2 shows a prior art lock activation device known from e.g. EP patent application no. 2762661, the disclosure of which is hereby incorporated by reference.

Lock activation devices of this kind are well known in many different embodiments, all having a housing 1 encapsulating at least one electric motor, a control system configured for activation of the electrical motor, and a rotatable activator axle 2 connected to the electrical motor via a transmission and extending out of the housing 1 through the base plate 3. Except form the activator axle 2 the components encapsulated by the housing 1 are not shown in detail as it is apparent to the skilled person that such components may be employed in many different embodiments.

The lock activation device shown in FIGS. 1 and 2 further comprises an electrical power supply comprising one or more electric batteries for supplying electricity to the electric motor and the control system, and a manual handle 4 for turning the activator axle 2 manually.

The embodiment of the lock activation device 1 shown in FIGS. 1 and 2 is configured for being mounted on one surface of e.g. a standard door wing having a lock arranged in the door wing, and in this situation the lock activation device replaces e.g. a key operated cylinder lock or a manual lock handle, so that the lock in the door wing is possible to be operated e.g. via radio signals or other remote operation.

For this purpose the lock activation may be mounted as shown in principle in FIG. 3 where a section of a door wing 5 with a door handle 8 and a doorframe 6 is shown in principle with the lock activation device mounted according to prior art with punctured lines. In this position the activator axle 2 of lock activation device 1 extends through a hole in the door wing and into the lock arranged therein, and where it engages with a mechanism in the lock so that when the activator axle 2 is turned by the electrical motor in the lock activation device, then the lock catch 7 is either shifted to its locked or unlocked position.

As it is apparent from FIG. 3, however. It will be necessary in order to mount the lock activator device in this position requires that some of the doorframe needs to be cut away in order to provide sufficient space for housing of the lock activation device.

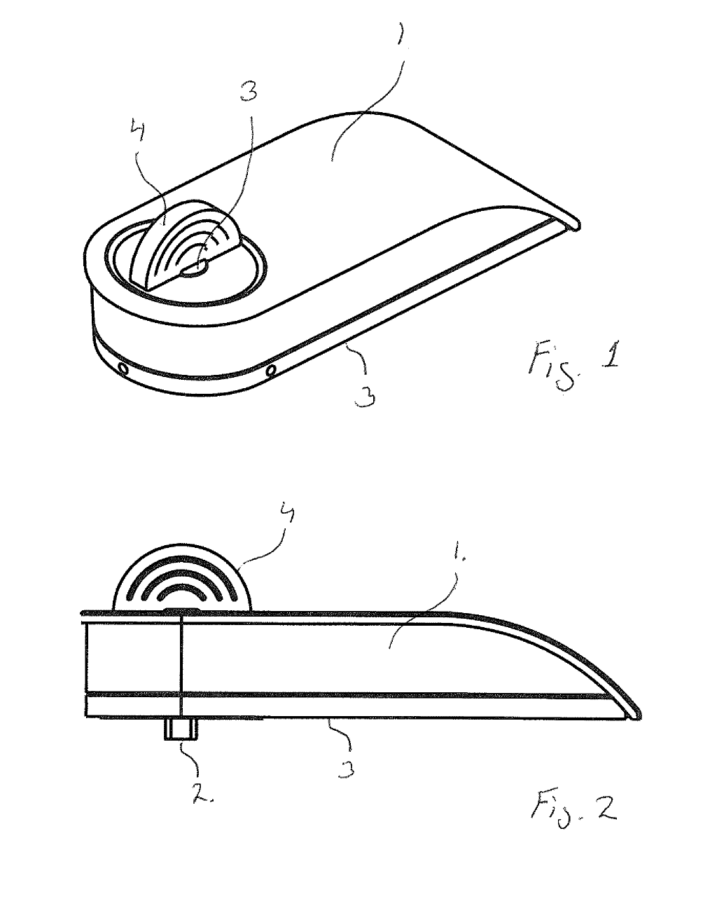

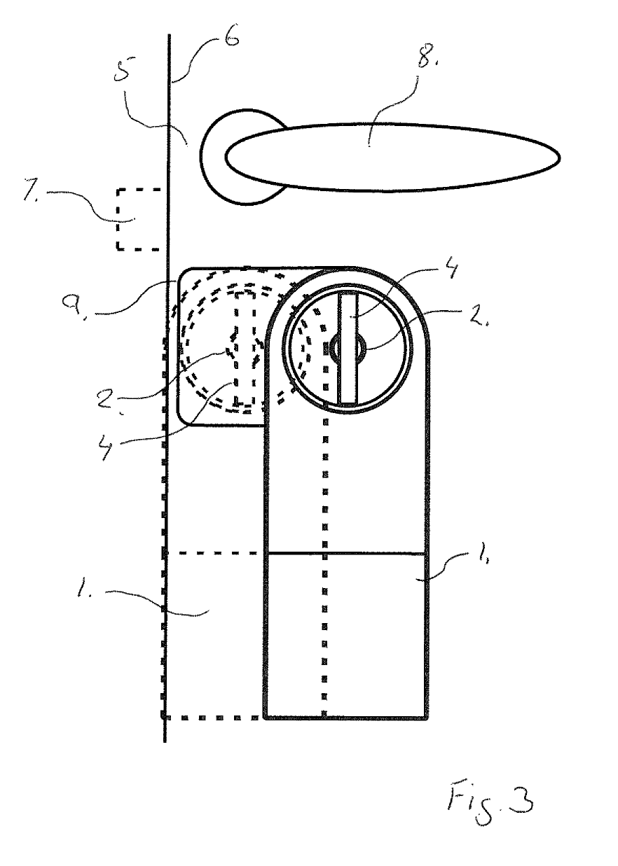

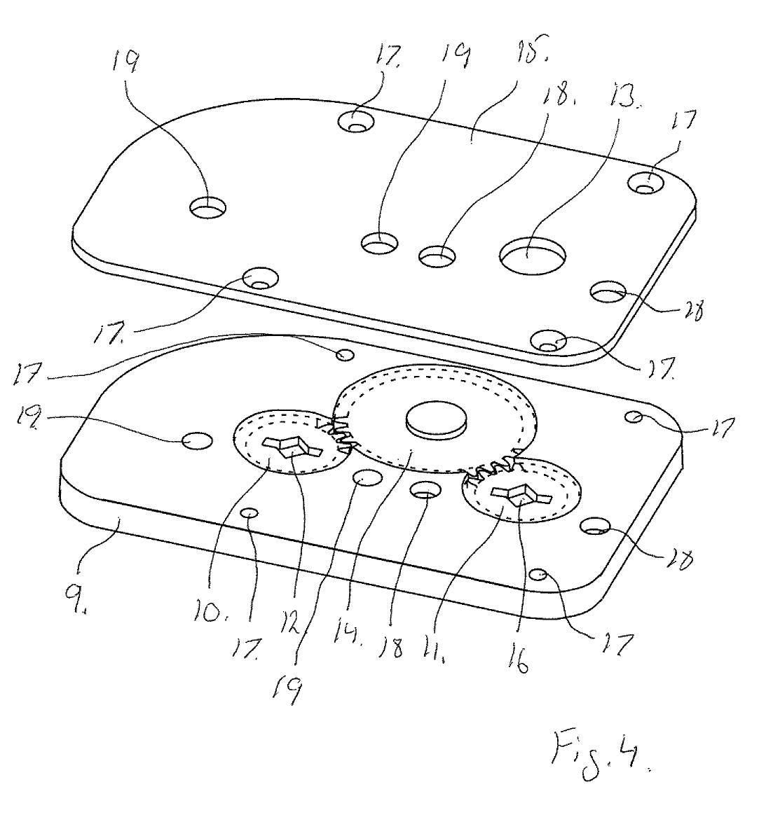

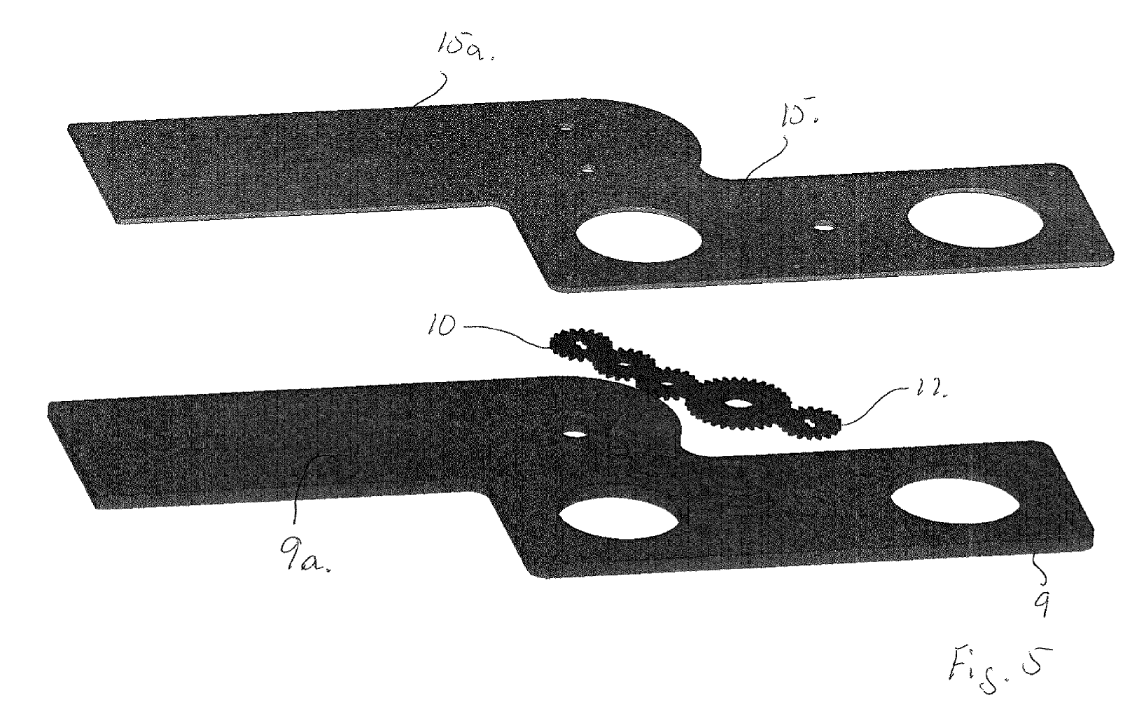

According to the invention, however, the lock activation device further comprises an adaptor plate 9 as shown in more detail in FIG. 4, so that it is possible to mount the housing 1 of the lock activation device in a safe distance from the door frame 6.

In FIG. 4 one this embodiment of the adaptor plate 9 is shown in an exploded view and comprises a first 10 and a second 11 transmission element where the first transmission element 10 is a first cog wheel 10 with a central axle hole 12 adapted for being connected with the activator axle 2 extending out from the base plate 3 on the housing 1, and so that the first cog wheel 10 rotates with the activator axle 2. In the same way the second transmission element 11 is a second cog wheel 11 having a central axle hole 16 that may be connected with a lock axle (not shown) extending out from the surface of the door wing 5 and through the lock axle hole 13 in the cover plate 15.

The first cog wheel 10 and the second cog wheel 11 in mutually connected via a third cog wheel 14, so that all the cog wheels 10, 11 and 14 rotates simultaneously.

Thereby the adaptor plate 9 provides the option of positioning the housing of the lock activation device at a distance from the doorframe as shown in FIG. 3. Alternatively the adaptor plate 9 provides the option of using a lock activation device having an activator axle 2 being incompatible with the lock in the door wing due to a different cross section of the activator axle 2 and the lock axle. This would only require that the central axle hole 12 of the first cog wheel 10 is adapted for engaging with the activator axle 2 and the central axle hole 16 of the second cog wheel 11 is adapted for engagement with the lock axle (not shown). In this manner the adaptor plate allows that the lock activation device may be adapted for use with different lock systems just by exchanging the second cog wheel 11.

As shown in FIG. 4 the adaptor plate is provided with indentations for holding the cog wheels in their respective positions, but allowing them to rotate. Furthermore the adaptor plate 9 and the cover plate 15 are provided with screw holes 17 for screw mounting the cover plate 15 on the adaptor plate 9, and with screw holes 18 and 19 for mounting the adaptor plate 9 to the lock in the door wing and to the housing 1 respectively.

An alternative embodiment of an adaptor plate is shown in FIG. 5 where the adaptor plate 9 and the cover plate 15 are configured for being mounted on a door wing with a different lock mechanism. This embodiment is in principle identical to the embodiment shown in FIG. 4, but with further cog wheels arranged for connecting the first 10 and the second 11 cog wheels, and with a different design of the outer periphery of the adaptor plate 9 and the cover plate 15. In this embodiment the adaptor plate 9 and the cover plate 15 comprises a section 9a and 15a having an outer periphery being shaped so that it extends along with the corresponding outer periphery of the base plate 3 of the housing 1.

1. A lock device configured for activating the lock catch of a lock by rotating a lock axle between a locked and an unlocked position, the lock device comprising:
a lock activator with a housing including a base plate, at least one electrical motor, a control system configured for activation of the electrical motor, and a rotatable activator axle connected to the electrical motor via a transmission and extending out of the housing through the base plate,
the lock device further comprising:
an adaptor plate including a front surface configured for releasable attachment of the base plate of the housing, and a through hole arranged so that the rotatable activator axle extends through the through hole and out from a rear surface opposite to the front surface on the base plate, and
where a set of transmission elements are arranged on the rear surface of the base plate,
the transmission element including at least a first transmission element connected to the activator axle, and a second transmission element configured for being connected to the lock axle, and
where the transmission elements are configured for urging the second transmission element, and thereby the lock axle, to rotate, when the rotatable activator axle is rotated.

2. A lock device according to claim 1, wherein the first and the second transmission element are cog wheels, being directly interconnected or indirectly via a one or more further cog wheels, tooth racks or other toothed elements, and where each of the first and the second cog wheels have a central through hole configured for mounting the first and the second cog wheel on the activator axle and lock axle respectively, so that the cog wheels rotate with the axles.

3. A lock device according to claim 2, comprising an odd number of further cog wheels.

4. A lock device according to claim 1, wherein the first and the second transmission element are sprockets, being interconnected via a toothed belt or a chain.

5. A lock device according to claim 1, wherein the adaptor plate comprises a cover plate connected to the base plate, and covering the set of transmission elements so that they are enclosed between the base plate and the cover plate.

6. A lock device according to claim 5, wherein the cover plate is a metal plate and the base plate is made from plastic and preferably from a thermosetting plastic material.

7. A lock device according to claim 6, wherein the cover plate has a through hole allowing a lock axle to extend through the cover plate, and to be connected with the second transmission element, and where the base plate extends over the through hole in the cover plate.

8. A lock device according to claim 5, 6 or 7, wherein the cover plate or the base plate has projections or indentations arranged on the side facing the base plate or the cover plate respectively, and where the projections or indentations are configured for positioning the transmission elements.

9. A lock device according to claim 5, wherein the complete outer periphery of the base plate extends along the complete outer periphery of the cover plate.

10. A lock device according to claim 2, wherein the through holes in the first and the second cog wheel are identical.

11. A lock device system comprising a lock activator and at least two adapter plates according to claim 1, wherein the distance between the first and the second transmission element of one of the adapter plates is different from the distance between the first and the second transmission element of another one of the adapter plates.

12. A lock device according to claim 6, wherein the cover plate or the base plate has projections or indentations arranged on the side facing the base plate or the cover plate respectively, and where the projections or indentations are configured for positioning the transmission elements.

13. A lock device according to claim 7, wherein the cover plate or the base plate has projections or indentations arranged on the side facing the base plate or the cover plate respectively, and where the projections or indentations are configured for positioning the transmission elements.

14. A lock device according to claim 6, wherein the complete outer periphery of the base plate extends along the complete outer periphery of the cover plate.

15. A lock device according to claim 7, wherein the complete outer periphery of the base plate extends along the complete outer periphery of the cover plate.

16. A lock device according to claim 8, wherein the complete outer periphery of the base plate extends along the complete outer periphery of the cover plate.

17. A lock device according to claim 3, wherein the through holes in the first and the second cog wheel are identical.
